(19) United States
(12) Patent Application Publication
(10) Pub. No.: US 2003/0088853 A1
(43) Pub. Date: May 8, 2003

(54) Trace information searching device and method therefor

(76) Inventors: Hiromi Iida, Moriguchi-shi (JP); Norio Sanada, Kobe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/287,710

(22) Filed: Nov. 5, 2002

(30) Foreign Application Priority Data
Nov. 7, 2001 (JP) 2001-341657

(51) Int. Cl. G06F 9/44; G06F 15/16

(52) U.S. Cl. 717/128; 709/217

(57) ABSTRACT

A trace information holding unit (1100) acquires and memorizes information indicating operations of an application program module (1011) (trace information) to be executed on a multitasking OS (1012). A search condition input unit (1210) accepts two or more pieces of information from an operator as search conditions. A search condition memory unit (1220) memorizes the accepted search conditions. A searching unit (1230) performs a search among the trace information stored in a trace information memory unit (1120) based on search conditions. A search result displaying unit (1240) displays a search result.

### BACKGROUND OF THE INVENTION

(1) Field of the Invention

The present invention relates to a device which supports debugging of an application program to be executed on an OS (operating system), and more particularly to a device which displays and verifies information indicating the operating situation of an application program to be executed on a multitasking OS.

(2) Description of the Related Art

In a conventional debugging of an application program (to be referred to also as “application” hereinafter) to be executed on a multitasking OS, a person who performs debugging finds an abnormal operation of the application and fixes it by observing how the application operates at runtime and by analyzing its operating situation according to an operation history acquired while the application is running.

As a technology to support such debugging activity and detect an abnormal operation in an application, there exist “PROCESS MONITORING DEVICE AND METHOD THEREFOR” disclosed in the Japanese Laid-Open Patent Application No.H9-305443 (Related Art 1) to check whether the application operates abnormally or not by storing its reference data corresponding to the pre-defined operations of the application (e.g. function) and by comparing it with operation data acquired from the actual operation of the application, and “HISTORY DISPLAY METHOD AND DEVICE THEREFOR” disclosed in the Japanese Laid-Open Patent Application No.H10-154056 (Related Art 2) to record process variables detected in a process controlling device as history data on a time series basis and search the history data by setting a combination of tendencies of changes in the process variables to be witnessed every specified period as search conditions for searching the history data.

However, the technology disclosed in the above Related Art1 is intended only for debugging a single kind of event, that is, “function execution” as the operation history. Furthermore, the technology disclosed in the above Related Art2 aims only at a single kind of information change, that is, “value of process variable” as a search condition. In other words, with these conventional technologies, it is impossible to see the occurrence of two or more kinds of events to be occurring while an application is running, nor is it possible to set information concerning two or more kinds of events as search conditions.

Moreover, in an application to be executed on a multitasking OS, there occurs an event such as interrupt processing which occurs in unpredictable timing. And when the recorded operation history includes an event which occurs unpredictably as mentioned above but which is normal, such event should be treated as a normal event. However, since it is impossible to make a judgment whether such event is normal or abnormal with the technologies disclosed in the Related Art 1 and the Related Art 2, the operator is required to make a judgment on this, which results in a longer debugging time.

### SUMMARY OF THE INVENTION

The present invention aims at providing a trace information searching device capable of carrying out an efficient debugging based on trace information even when an application running on a multitasking OS is required to make a verification for two or more kinds of events and for information concerning such events. In other words, a device or a method is provided which can perform a search among an acquired trace information to detect and display a part where a desired OS operation is taking place to efficiently specify a defective part in an application by specifying conditions concerning OS operations. Furthermore, a device or a method is provided which can perform a search among the trace information to detect and display a part where a desired OS operation is taking place to efficiently specify a defective part of all kinds of events in an application by specifying the occurrence order of two or more kinds of OS operations, that is to say, a task transition occurrence event, an interrupt occurrence event, and a system call issue event.

In order to achieve the above objects, the trace information searching device according to the present invention is a trace io information searching device which performs a search, under specific search conditions, among trace information indicating an operation history of an application program which operates on a specified operating system and in which two or more kinds of events occur, the trace information searching device comprising: a trace information acquiring unit operable to acquire the trace information on a time series basis; a search condition acquiring unit operable to acquire search conditions concerning the events; a searching unit operable to search trace information which matches the acquired search conditions among the acquired trace information; and a search result displaying unit operable to display the contents of trace information searched by the searching unit.

Accordingly, it becomes possible to perform a search among the trace information to detect and display a part where a desired OS operation is taking place. That is to say, a device capable of efficiently specifying a defective part in an application can be realized.

Furthermore, the trace information searching device according to the present invention is a trace information searching device, wherein the search conditions include information indicating an occurrence order of the events.

Accordingly, it becomes possible to perform a search among the trace information to detect and display a part where an OS operation is taking place in the desired order. That is to say, a device capable of efficiently specifying a defective part in an application based on the occurrence order of events can be realized.

Moreover, the trace information searching device according to the present invention is a trace information searching device, wherein the search conditions further include information indicating an occurrence interval of the events.

Accordingly, it becomes possible to perform a search among the trace information to detect and display a part where an OS operation is taking place also with time taken into consideration. That is to say, a device capable of efficiently specifying a defective part in an application also by taking into consideration time can be realized.

What is more, the trace information searching device according to the present invention is a trace information searching device, wherein the search conditions further include information concerning an event indicating that the event shall be treated as not having occurred when the search is performed.

Accordingly, it becomes possible for the operator to ignore OS operations not needed for analyzing a defective part in an application so as to search for only a part where a desirable OS operation is taking place. That is to say, a device capable of efficiently specifying a defective part in an application in a more detailed manner by specifying events to be ignored at search time can be realized.

Furthermore, the trace information searching device according to the present invention is a trace information searching device, wherein the search conditions further include: information indicating an occurrence interval of the events; and information concerning an event indicating that the event shall be treated as not having occurred when the search is performed.

Accordingly, it becomes possible to perform a search among the trace information to detect only a part where a desirable OS operation is taking place with time taken into consideration and with events not needed by the operator to analyze a defective part ignored. That is to say, a device capable of efficiently specifying a defective part in an application in a more detailed manner by considering time and by specifying events to be ignored at search time can be realized.

Moreover, the trace information searching device according to the present invention is a trace information searching device, wherein the search condition acquiring unit comprising: a time chart displaying unit operable to display the trace information as a time chart; a specified period extracting unit operable to accept specification of an arbitrary period on the time chart and to extract trace information corresponding to the time chart of the specified period as trace information to be searched; and a search condition creating unit operable to acquire and create the search conditions on the time chart from among the extracted trace information.

Accordingly, it becomes possible to visually grasp a desirable OS operation on the time chart and input of search conditions also becomes easy. That is to say, a device or a method allowing for an easy input of search conditions and capable of efficiently specifying a defective part in an application can be realized.

Meanwhile, in order to achieve the above objects, the present invention can be realized as a method which has the component units of the above device as steps and as a program having such steps to realize on a general-purpose computer a function equivalent to the above trace information searching device by having the computer load that program. In other words, the present invention makes it possible to freely choose where to perform debugging and to carry out an activity needed to specify a defective part in an application without constrains of time and place, as long as the above-mentioned computer can be installed in such a place. Moreover, not only is it possible to store such program in a storage medium such as CD-ROM in the device, it can also be distributed via a transmission medium such as a communication network.

As stated above, according to the present invention, it is possible to perform a search among the trace information to detect and display a part where a desired OS operation is taking place also with such an event as interrupt processing whose occurrence time cannot be predicted and time concerning an event which is not needed for knowing a defective part in an application taken into consideration. Furthermore, by allowing a part of the trace information to be extracted based on a period accepted on a time chart and allowing search conditions to be created by using the extracted part of the trace information, a desired OS operation can be visually grasped on the time chart and input of search conditions also becomes easy. In other words, the present invention makes it possible to realize a device or a method which allows for easier input of search conditions and which can visually specify a defective part in an application.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is a diagram showing a functional configuration of a trace information searching device according to the First Embodiment.

FIG. 2 is a diagram showing an example of trace information to be stored in a trace information memory unit in the trace information searching device as shown in FIG. 1.

FIG. 3 A is a diagram showing an example of an event occurrence order table according to the First Embodiment and the Second Embodiment.

FIG. 3B is a diagram showing an example of a rejection event table according to the First Embodiment and the Second Embodiment.

FIG. 4 is a flowchart showing an overall processing flow of the trace information searching device according to the First Embodiment.

FIG. 5 is a flowchart showing a detailed flow of search processing according to the First Embodiment and the Second Embodiment.

FIG. 6 is a diagram showing an example of trace information for search to be created at search processing time according to the First Embodiment and the Second Embodiment.

FIG. 7 is a diagram showing an example of the trace information for search after the completion of search processing according to the First Embodiment and the Second Embodiment.

FIG. 8 is a diagram showing an example of how a search result is displayed according to the First Embodiment and the Second Embodiment.

FIG. 9 is a diagram showing a functional configuration of the trace information searching device according to the Second Embodiment.

FIG. 10 is a diagram showing an example of how a time chart corresponding to the trace information is displayed according to the Second Embodiment.

FIG. 11 is a diagram showing how a part of the period on the time chart is specified by a search condition creating unit according to the Second Embodiment.

FIG. 12 is a diagram showing the contents of the trace information corresponding to the period specified in FIG. 11.

FIG. 13 is a diagram showing an example of how search conditions are set on the time chart.

FIG. 14 is an example of an event occurrence order table according to the Second Embodiment.

FIG. 15 is an example showing the result of a search performed by using the event occurrence order table in FIG. 14.

FIG. 16 is an example of another event occurrence order table according to the Second Embodiment.

FIG. 17 is a diagram showing the result of a search performed by using the event occurrence order table in FIG. 16.

FIG. 18 is a flowchart showing an overall processing flow of the trace information searching device according to the Second Embodiment.

FIG. 19 is a diagram showing an example of a hardware configuration in the case where each function of the trace information searching device is realized by using a CPU and others.

### DESCRIPTION OF THE PREFERRED EMBODIMENT(S)

The following is an explanation of the trace information searching device 1000 according to the embodiment of the present invention with reference to the figures.

The First Embodiment

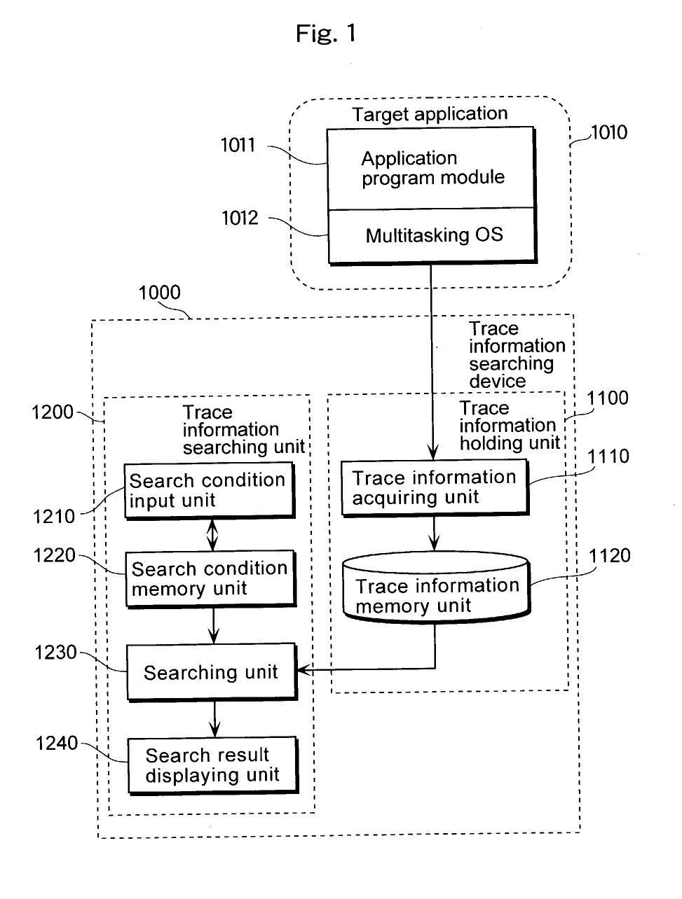

FIG. 1 is a functional configuration diagram illustrating the trace information searching device 1000 in the present embodiment. In FIG. 1, a target application 1010 is a program to be debugged by the trace information searching device 1000.

The target application 1010 is comprised of an application program module 1011 and a multitasking OS (operating system) 1012. The application program module 1011, which is made up of one or more tasks, operates on the multitasking OS 1012.

The multitasking OS 1012 has a function of outputting such event occurrence-related information (to be referred to as “event occurrence information” hereinafter) as an OS state, occurrence of a task transition, occurrence of an interrupt and an issue of a system call, while the application program module 1010 is running.

The trace information searching device 1000 is comprised of a trace information holding unit 1100 and a trace information searching unit 1200. Furthermore, the trace information holding unit 1100 is made up of a trace information acquiring unit 1110 and a trace information memory unit 1120. Although not shown in FIG. 1, the trace information searching device 1000 has a controlling unit which controls each unit of the trace information holding unit 1100 and each unit of the trace information searching unit 1200. This controlling unit includes ROM where a control program is stored, as well as RAM and others.

The trace information acquiring unit 1110 acquires event occurrence information concerning events to be occurring on an OS which are extracted and outputted by the multitasking OS (e.g. occurrence of a task transition, occurrence of an interrupt, an issue of a system call etc.) while the target application 1010 is running, as trace information on a time series basis.

For example, the trace information memory unit 1120 can be a hard disk, on which trace information acquired by the trace information acquiring unit 1110 is stored.

The subsequent paragraphs provide an explanation of trace information.

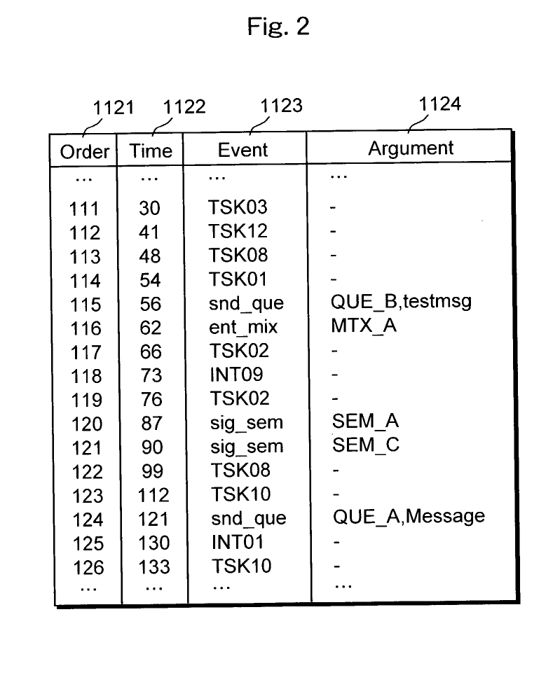

FIG. 2 is a diagram showing an example of trace information to be stored in the trace information memory unit 1120. As shown in FIG. 2, the trace information is stored as information in which information indicating “order 1121,” “time 1122,” “event 1123” and “argument 1124” relate to one another.

The order 1121 is a serial number to be assigned to events to indicate the order of event occurrence. The time 1122 is a piece of information indicating the elapsed time (for example, given in (ms)) from a certain time point (e.g. start time of the execution of the target application). The argument 1124 represents an argument to be used for a system call and others.

A task name is recorded in the event 1123 column in FIG. 2 when a transition to a task occurs (in FIG. 2, the description is given as “TSK”+“a number representing ID number”). When an interrupt processing occurs, an interrupt task name is recorded (in FIG. 2, the description is given as “INT”+“a number representing ID number”). Furthermore, when a system call is issued, a system call name is recorded (in FIG. 2, the description is given as “sig_sem” “send_que” etc.).

The trace information searching unit 1200 is made up of a search condition input unit 1210, a search condition memory unit 1220, a searching unit 1230 and a search result displaying unit 1240.

The search condition input unit 1210 provides a user interface to be used for inputting search conditions when a search is performed among the trace information.

An example of search conditions can be represented by the combinations of information indicating the occurrence order of a task transition occurrence event, an interrupt occurrence event or a system call issue event, as well as the occurrence interval of each event and information indicating whether to treat occurrence of each event as a search target or not.

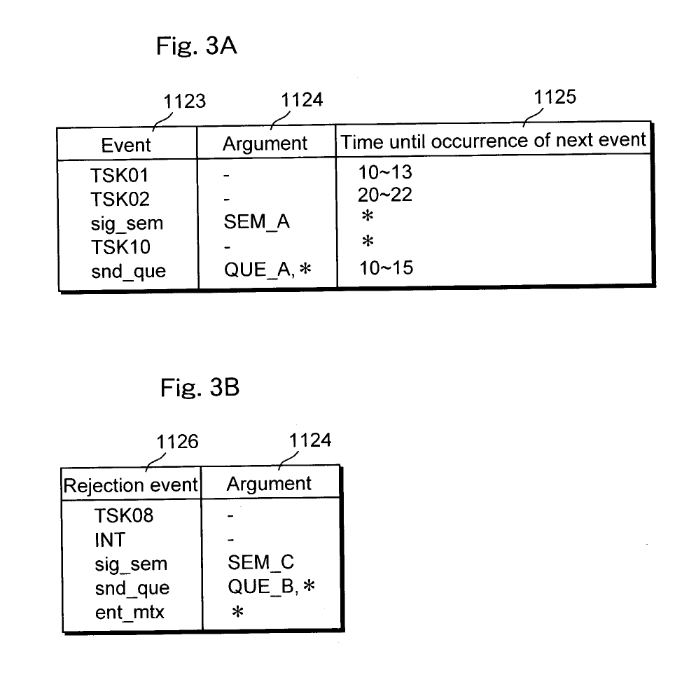

FIG. 3 is a diagram showing an example of the above-mentioned search conditions. FIG. 3 A provides an example of an event occurrence order table in which the occurrence order of each event and the occurrence interval of each event are described in table form. FIG. 3 B is an example of a rejection event table in which events to be ignored at search time are described in table form. In this case, the search condition input unit 1210 refers to the search condition memory unit 1220 so that events to be described in the rejection event table will not be described in the event occurrence order table. Hereinafter, a “search condition” indicates a set of information described in each line of an event occurrence order table and a rejection event table, while each piece of information making up a search condition is referred to as a “search element.” Therefore, the event 1123, the argument 1124, the rejection event 1126 and others in FIG. 3 A or B are search elements.

In creating an event occurrence order table, concerning a 10 task transition occurrence event and an interrupt occurrence event, when an ID number is described, an event which matches even that ID number serves as a search element, and when an ID number is not described, the fact that a task transition event or an interrupt occurred serves a search element, in which case an ID number is excluded as a search element. Moreover, regarding a system call issue event, a system call name and the contents of an argument serve as search elements, and when “*” is described instead of an argument, only the fact that there was an issue of the system call will be used as a search element regardless of an argument used for the system call.

Furthermore, by describing “*” in the time until the occurrence of the next event 1125 column, it is possible not to set a time described in the column as a search element. For example, in FIG. 3 A, the time from when a system call “sig_sem” whose argument is “SEM_A” is issued to when a transition to the next “TSK10” occurs, and the time from when a transition to “TSK10” occurs to when the next system call “snd_que” is issued are not included as search elements.

In FIG. 3A, in addition to that events occurred in the order of transition occurrence to “TSK01,” transition occurrence to “TSK02,” an issue of a system call “sig_sem” whose argument is “SEM_A,” transition occurrence to “TSK10,” and a system call “snd_que” whose first argument is “QUE_A” and the second argument is an arbitrary value, is used as search elements, the fact that the elapsed time from when an event “TSK01” occurs to when an event “TSK02” occurs is 10˜13 (ms) as shown in the time until the occurrence of the next event 1125 column is also included as a search element.

In FIG. 3B, it is also shown that occurrence of “TSK08,” occurrence of a certain kind of interrupt event, an issue of a system call “sig_sem” whose argument is “SEM_C,” occurrence of a system call “send_que” whose first argument is “QUE_B” and the second argument is an arbitrary value, and an issue of a system call “ent_mtx” having an argument are ignored as search elements.

The search condition memory unit 1220, which can be a storage device such as RAM, memorizes search conditions, i.e. the contents of the event occurrence order table and the rejection event table, inputted from the search condition input unit 1210.

The searching unit 1230 searches for trace information which matches search conditions stored in the search condition memory unit 1220 among the trace information stored in the trace information memory unit 1120.

After the search is performed by the searching unit 1230, the search result displaying unit 1240 displays trace information which matches the search conditions stored in the search condition memory unit 1220 and other trace information in a distinctive manner so that their difference can be visually recognized.

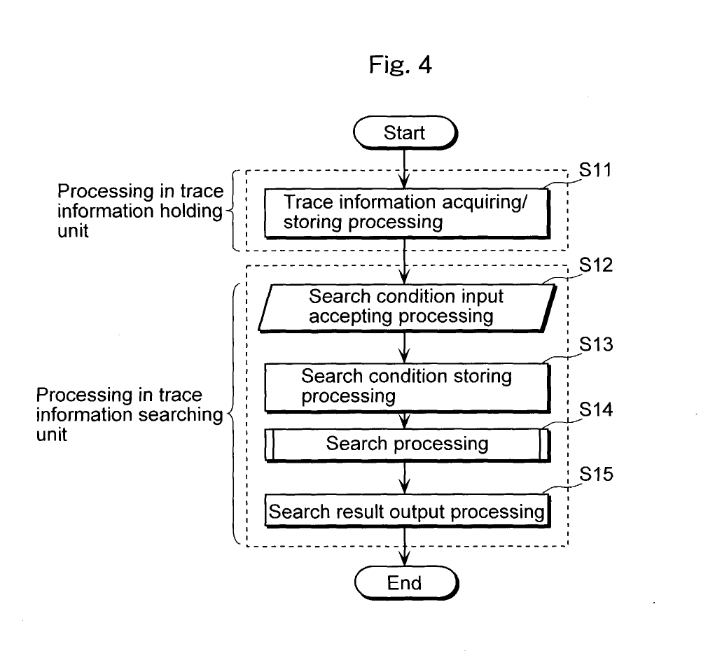

The following is an explanation of the operation of the trace information searching device 1000 in the First Embodiment. FIG. 4 is a flowchart showing an overall processing of the trace information searching device 1000.

While the target application is running, the trace information memory unit 1100 memorizes trace information acquired by the trace information holding unit 1110 in the trace information memory unit 1120 (Step S11). Then, the search condition input unit 1210 accepts search conditions inputted by the operator, i.e. information to be described in the event occurrence order table and the rejection event table (Step S12), and the search condition memory unit 1220 memorizes these search conditions (Step S13).

Next, the searching unit 1230 performs a search among the trace information by using the search conditions stored in the search condition memory unit 1220 (Step S14) and displays the result on the search result displaying unit 1240 (Step S15).

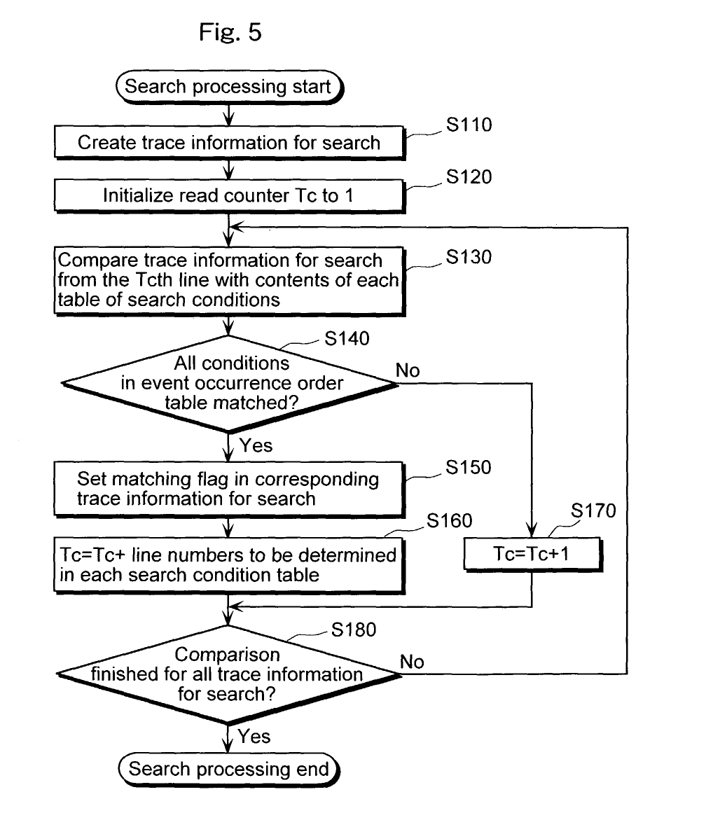

The subsequent paragraphs provide a detailed explanation of 10 search processing (Step S14) illustrated in FIG. 4. FIG. 5 is a detailed flowchart showing the search processing.

First, the searching unit 1230 creates trace information for search, which is added with a “matching flag” column to the trace information stored in the trace information memory unit 1120 to show a search result (Step S110). Furthermore, since the searching unit 1230 ignores the events described in the rejection event table stored in the search condition memory unit 1220 at search time, such events described in the rejection event table are excluded from the trace information for search when creating trace information for search. Moreover, by not describing the events described in the rejection event table in the trace information for search, the searching unit 1230 deletes all events except for the one with the earliest occurrence time, since, when exactly the same task transition occurrence events are listed in multiple number in the trace information for search, it is impossible that a transition to the same task occurs more than once in succession as an actual OS operation.

For example, when creating trace information for search based on the trace information of FIG. 2 and the rejection event table of FIG. 3B, since “INT” is described in the rejection event table, not all interrupt occurrence events will be described in the trace information for search. For this reason, since events whose value in the order 1121 column in FIG. 2 (to be abbreviated as “the order” hereinafter) are “117,” “118” and “119” fall on “TSK02,” “INT09,” and “TSK02” respectively, two events “TSK02” for the orders “117” and “119” serve as trace information with the event “INT09” whose order is “118” being excluded. However, since the same events “TSK02” are listed in sequence, only the event“TSK02” of “117” with the earlier occurrence time is left for the trace information for search.

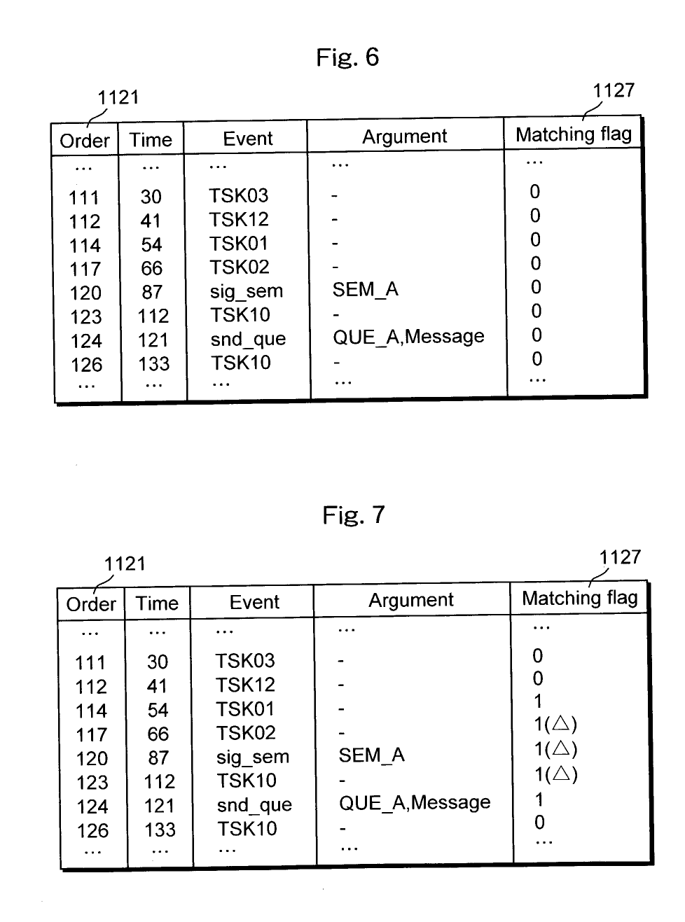

An example of the trace information created by following the above-mentioned steps is illustrated in FIG. 6. FIG. 6 shows a part of the trace information created based on the trace information in FIG. 2 and the rejection event table in FIG. 3B. This trace information for search is the information from which the trace information is partly deleted to realize an efficient search for trace information and from which the information described in the rejection event table in FIG. 3B is deleted by the line from the trace information in FIG. 2.

FIG. 6 shows that events whose order 1121 in FIG. 2 is “118” and “119” are deleted from FIG. 6 because they are described in FIG. 3B above. Also in FIG. 6, the matching flag 1127 column in which the result of a comparison (i.e. a search result) made with search conditions is described is provided in addition to the four columns of the trace information (the order 1121, the time 1122, the event 1123 and the argument 1124) shown in FIG. 2. Note that this matching flag is set to “0” which indicates “mismatching” at initialization time.

Next, the searching unit 1230 initializes to 1 a read counter Tc to be used for reading the trace information for search (Step S120) and further compares the trace information for search from the Tcth line onward with the information described in the event occurrence order table. In doing this, the searching unit 1230 takes into consideration the fact that “*” is described in the trace information for search and the event occurrence order table in connection to “event” and “argument.” Furthermore, if a value indicating the time until the occurrence of the next event 1125 is described in the event occurrence order table, the searching unit 1230 makes a comparison between the value described in the “time until the occurrence of the next event” in the event occurrence order table based on a value described in the time column in the trace information for search (i.e. calculate the difference between two values)(Step S130). When this is done, if a value in the time until the occurrence of the next event 1125 in the event occurrence order table is “*,” no comparison is made and the value is regarded as matching.

As mentioned above, the searching unit 1230 performs a comparison between the information from the Tcth line onward in the trace information for search and the information described in all Tn lines in the event occurrence order table (in the case of FIG. 3A, Tn=5), and when all conditions in the event occurrence order table are met (Step S140: Yes), from the Tcth line onward, values in the matching flag column are set to “1” which indicates “matching” by Tn consecutively (Step S150). In this case, the searching unit 1230 adds to a value Tc the number of lines to be determined according to each information in the event occurrence order table and the rejection event table to update the value Tc (Step S160).

If the information from the Tcth line onward in the trace information for search does not match the information described in all lines in the event occurrence order table, 1 is added to the value Tc for upgrade (Step S170).

After this, the searching unit 1230 checks if the value Tc exceeds the total line number of the trace information for search (Step S180), and if the value Tc has proven bigger than the total line number of the trace information for search, it terminates the search processing. If not, the searching unit 1230 returns to the processing to make a comparison between the above-mentioned trace information for search from the Tcth line onward and the information described in the event occurrence order table (Step S130).

In the above-mentioned example in FIG. 5, although the description is provided concerning the case where a comparison is made to check if the information described in all lines (Tn) in the event occurrence order table are matched or not, if information described in one or more lines out of Tn are matched, “Δ” can be described in the above-mentioned matching flag column 1127.

As a result of the above-mentioned search processing, values to be described in the matching flag column to show a search result are determined. FIG. 7 provides an example of a trace information for search table for which values to be described in the matching flag column were determined. Note that some of the values in the matching flag column are described as “(Δ)” in FIG. 7 to give a description example for the case where information described in some lines out of Tn lines are matched.

Next, the search result displaying unit 1240 newly adds a mark column to the trace information illustrated in FIG. 2 according to the contents of the trace information for search shown in FIG. 7 and describes “O” or “X” there. In doing this, the search result displaying unit 1240 regards events which are described in between the values “1” in the matching flag column 1127 and which are described in the rejection event table and deleted when the trace information for search is created, as matching. For events which are described in between the values “0” in the matching flag column 1127 and which are described in the rejection event table, as mismatching.

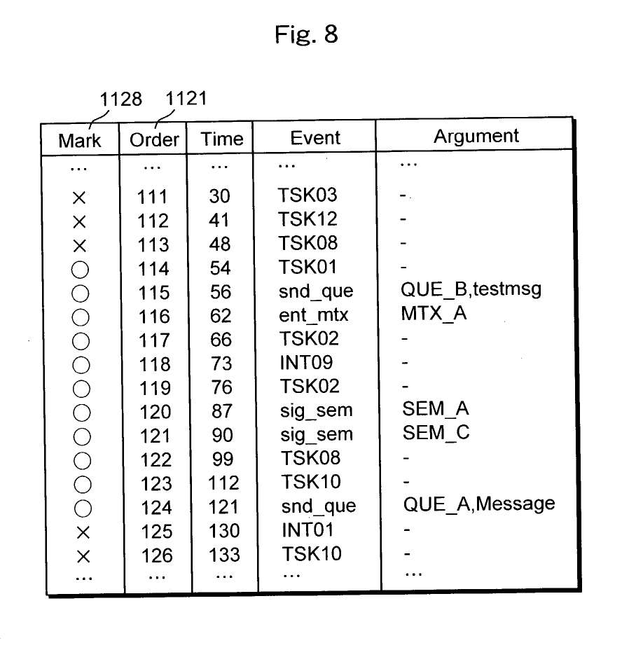

As mentioned above, the resulting table in which “O”/“X” is described in the mark column added to the trace information is displayed in a visually recognizable manner as shown in FIG. 8. In FIG. 8, a group of a series of events for which “O” is described in the mark column 1128 is regarded as an event group matching the order described in the event occurrence order table, and events for which “X” is described are regarded as mismatching.

As mentioned above, the trace information searching device 1000 makes it possible to separately display whether the application operates as desired according to the event occurrence order table in which the order of two or more kinds of events is set as a search element by the operator. Furthermore, since omission of an ID number and the use of “*” as an argument is allowed, it becomes lo possible for a wider range of event transitions to serve as a search target.

Moreover, since the trace information searching device 1000 allows the operator to describe the time indicating the occurrence interval of each occurrence event in the above-mentioned event occurrence order table, real-timeliness of the application can be checked as well.

What is more, by having the operator describe events to be ignored at search time in the rejection event table, the trace information searching device 1000 makes it possible to prevent a search result from ending up as “Non-desired OS operation” even when an unexpected event such as interrupt processing occurs. Furthermore, by utilizing the rejection event table, it is possible for the operator to check only the operation of events on which s/he wishes to focus attention.

As stated above, the use of the trace information device in the present embodiment makes it possible for the operator to efficiently perform a desirable search among the acquired trace information using a variety of search conditions and to easily specify a defective part in an application.

The Second Embodiment

In the First Embodiment, the explanation is given for the trace information searching device capable of setting search conditions which include two or more kinds of task transitions and others, but in this embodiment, an explanation is provided for a trace information searching device capable of setting search conditions and displaying a search result and others using a time chart.

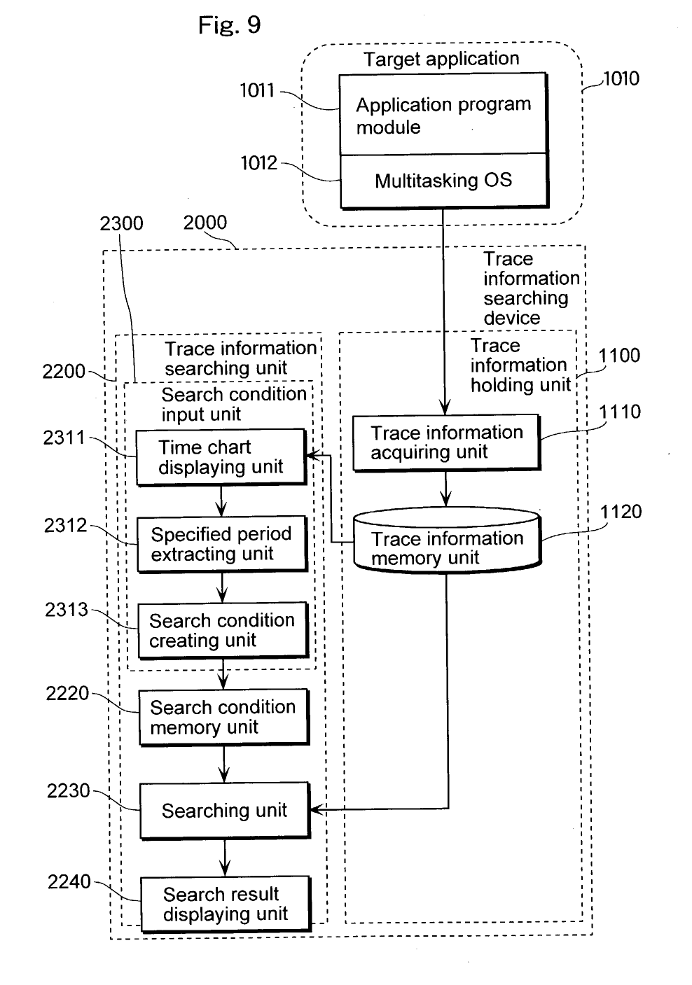

FIG. 9 is a functional configuration diagram of the trace information searching device 2000 according to the present embodiment. In FIG. 9, the target application 1010 is a program to be debugged by the trace information searching device 2000, which is the same program as the target application 1010 in the First Embodiment.

The trace information searching device 2000 is made up of a trace information holding unit 1100 and a trace information searching unit 2200. The configuration of the trace information holding unit 1100 is identical with that of the trace information holding unit 1100 in the First Embodiment. Although not illustrated in FIG. 9, the trace information searching device 2000 has all units of the trace information holding unit 1100 and a controlling unit to control all units of the trace information searching unit 2200. This controlling unit includes ROM where a control program is stored, as well as RAM and others.

The trace information searching unit 2200 is made up of a search condition input unit 2300, a search condition memory unit 2220, a searching unit 2230, and a search result displaying unit 2240. Furthermore, the search condition input unit 2300 is comprised of a time chart displaying unit 2311, a specified period extracting unit 2312 and a search condition creating unit 2313.

The time chart displaying unit 2311 reads out trace information from the trace information memory unit 1120 and displays the contents of the trace information in time chart form. This time chart makes it easy for the operator to visually grasp how each event transits from the standpoint of time.

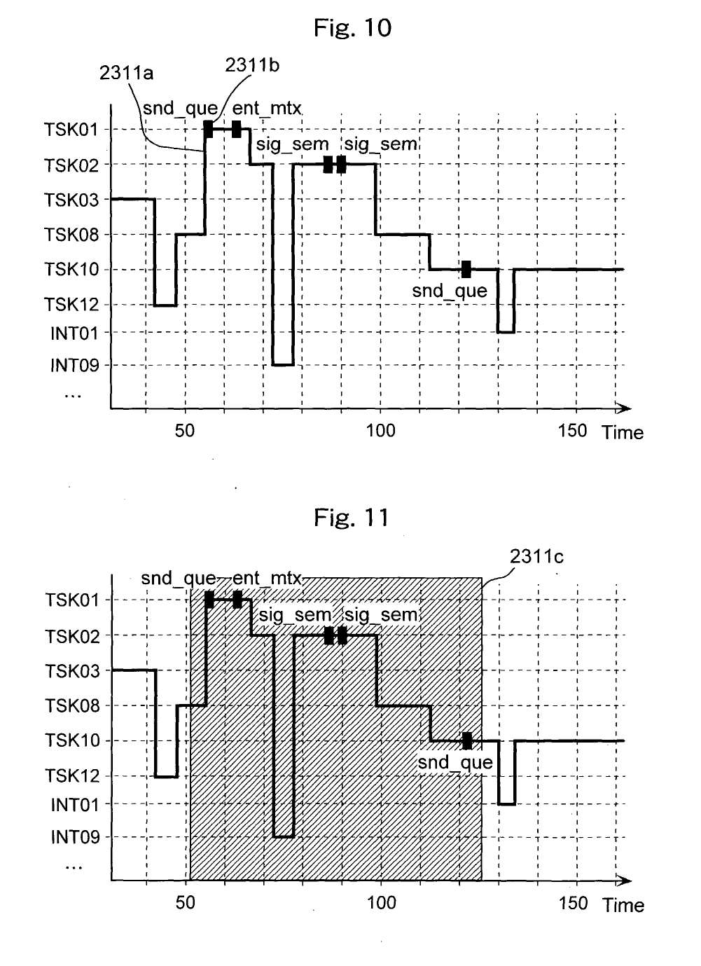

FIG. 10 is an example of the contents of the trace information of FIG. 2 in the First Embodiment represented in time chart form by the time chart displaying unit 2311. In the time chart in FIG. 10, the horizontal axis represents the time axis, while the vertical axis represents task names or interrupt processing names. In this time chart, while the situation of occurrence of tasks or interrupt processing is displayed by a broken line 2311a following the passage of time, an issue of a system call is indicated by a rectangular point on the broken line 2311a (e.g. a point 2311b).

On the time chart, the specified period extracting unit 2312 provides a user interface for accepting specification of a period to be searched by the operator and extracts trace information which corresponds to the specified period.

In contrast to the above-mentioned FIG. 10, FIG. 11 provides an example for the case where a period to be searched is specified by the specified period extracting unit 2312. In FIG. 11, the diagonally shaded area 2311c represents the operator-specified period to be searched.

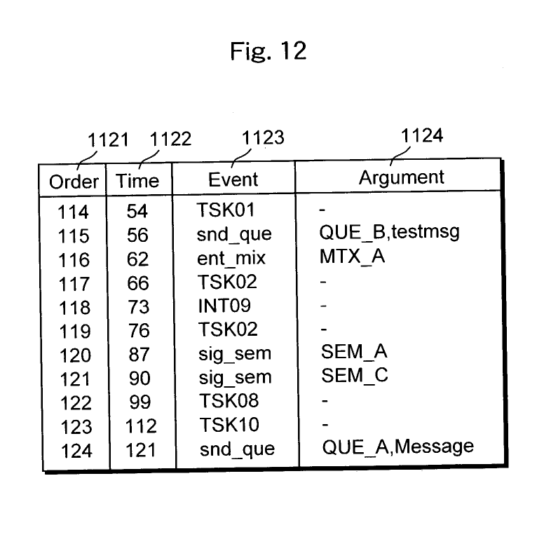

Provided in FIG. 12 is trace information corresponding to the above-mentioned specified period in FIG. 11 extracted by the specified period extracting unit 2312. As illustrated in FIG. 12, trace information corresponding to the specified period partly matches the trace information shown in full in the above-mentioned FIG. 2.

According to the trace information extracted by the specified period extracting unit 2311, the search condition creating unit 2313 provides a user interface for creating on a time chart an event occurrence order table and a rejection event table similar to those in the First Embodiment and stores the created information of the event occurrence order table and the rejection event table in the search condition memory unit 2220.

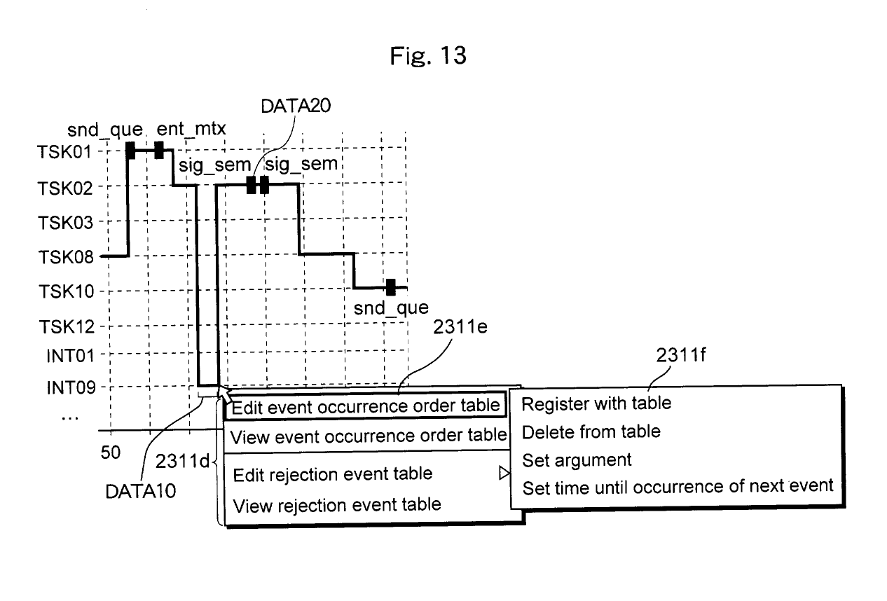

A detailed explanation of the function of this search condition creating unit 2313 is provided with reference to FIG. 13. FIG. 13 is an example of how the time chart corresponding to trace information extracted by the specified period extracting unit 2312 is displayed. Note that the time chart in FIG. 13 corresponds to the diagonally shaded area 2311c in FIG. 11.

Based on the time chart corresponding to the extracted trace information, the search condition creating unit 2313 selects parts of the time chart to register information corresponding to the selected parts of the time chart as search conditions of the event occurrence table and the rejection event table.

In FIG. 13, for example, when the operator selects (e.g. double-clicks) “DATA10 (a horizontal line to indicate INT09),” it means that s/he has selected an interrupt processing event “INT09” whose order in the trace information in FIG. 12 is “118.” Similarly in FIG. 13, when the operator selects “DATA20,” it means that s/he has selected a system call event “sig_sem” whose order in the trace information in FIG. 12 is “120.” Search elements the operator can specify for a selected event are whether to specify the ID number of a task or an interrupt processing as a search element, an argument for a system call, the time until the occurrence of the next event, and whether to ignore the event at search time (i.e. whether to register the event with the rejection event table) or not. When an operator whishes to ignore the selected event at search time, such event is added to the rejection event table. The above-mentioned operation, for example, can be performed from a pull-down menu 2311e and 2311f as illustrated in FIG. 13.

As above, accepting an operation from the operator on the time chart, the search condition creating unit 2313 makes a setting for information to be registered with the event occurrence order table and the rejection event table.

The search condition memory unit 2220, an example of which is a storage device such as RAM, memorizes search conditions, i.e. the contents of the event occurrence order table and the rejection event table, according to an instruction from the search condition input unit 2300, and memorizes image information (e.g. graphic information and coordinate information of each graphic) and others required for displaying their contents in time chart form.

Referring to the trace information stored in the trace information memory unit 1120 where necessary, the searching unit 2230 makes a comparison between trace information in an specified period extracted by the search condition input unit 2300 and the above-mentioned search conditions to acquire a search result. Then, the search result displaying unit 2240 displays the search lo result provided by the searching unit 2230 in time chart form.

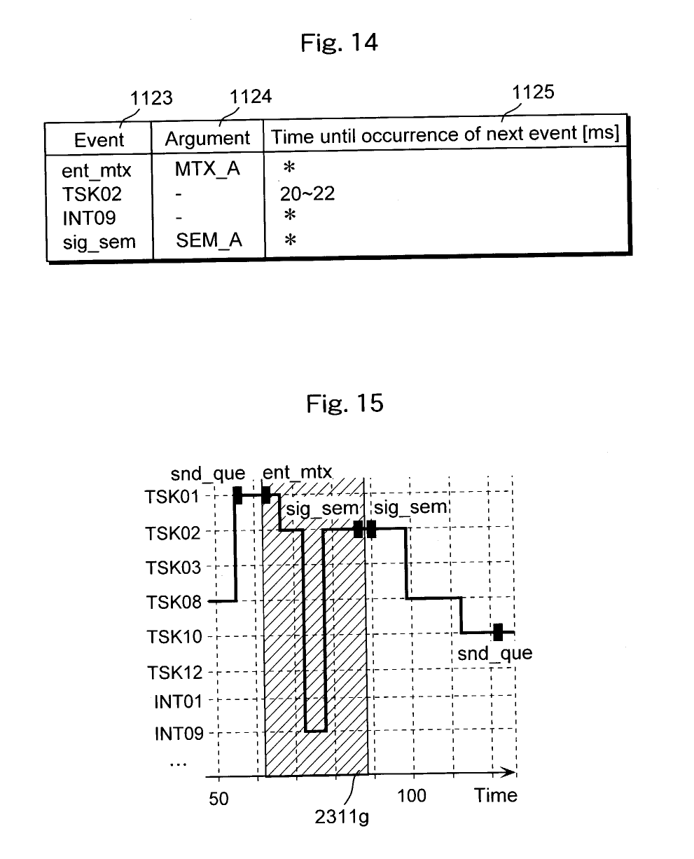

The following is a detailed explanation of the function of the searching unit 2230 in the present embodiment with reference to FIG. 14˜FIG. 17.

FIG. 14 is an example of the event occurrence order table in the present embodiment. The contents of this event occurrence order table is set according to an instruction from the operator on the time chart in the above-mentioned FIG. 11.

FIG. 15 is the result of a search performed in the searching unit 2230 by using the event occurrence order table in the above-mentioned FIG. 14, as well as an example of a search result in which all search conditions described in the event occurrence order table are matched. The diagonally shaded area 2311g in FIG. 15 is the part matching the contents of the event occurrence order table of the above-mentioned FIG. 14. In this case, there should be no specification from the operator concerning the contents of the rejection event table.

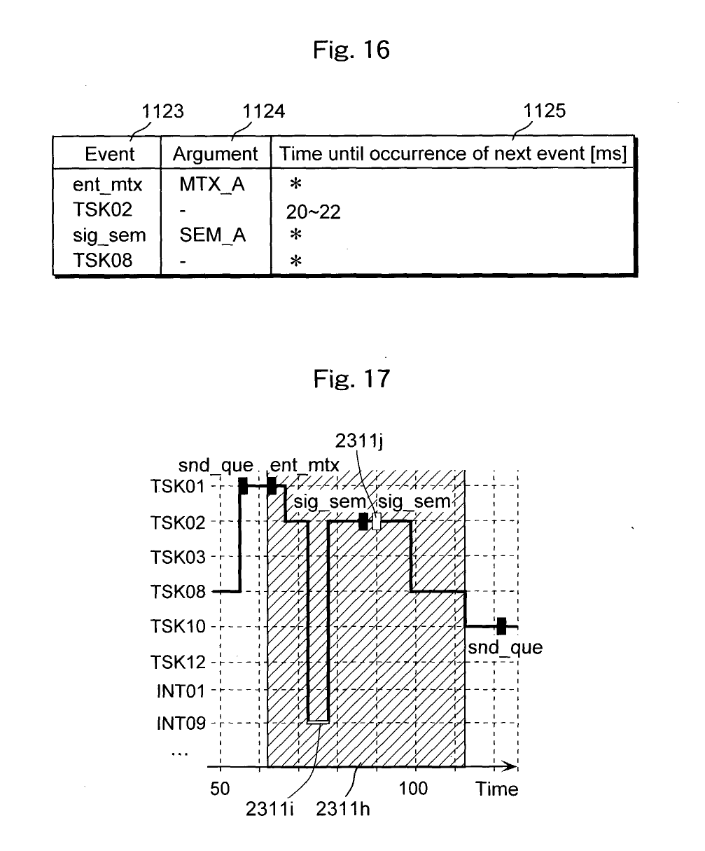

FIG. 16 provides an example of another event occurrence order table in the present embodiment. The contents of this event occurrence order table are also set according to an instruction from the operator on the time chart in the above-mentioned FIG. 11.

FIG. 17 is the result of a search performed in the searching unit 2230 for the above-specified period in the trace information by using the event occurrence order table in the above-mentioned FIG. 16, as well as an example of a search result when search conditions described in the event occurrence order table are partly matched. The diagonally shaded area 2311h in FIG. 17 is the part partly matching the search conditions described in the event occurrence order table of the above-mentioned FIG. 16. Although “INT09” occurs in FIG. 17, since “INT09” is not defined in the event occurrence order table in FIG. 16, a line 2311i indicating “INT09” is displayed as a white line. And although two system calls “sig_sem” are issued in succession in FIG. 17, there is only one system call “sig_sem” in the event occurrence order table in FIG. 16. For this reason, a rectangular point 2311j indicating the second system call “sig_sem” is displayed as an outlined square. Also in this case, there should be no specification from the operator concerning the contents of the rejection event table.

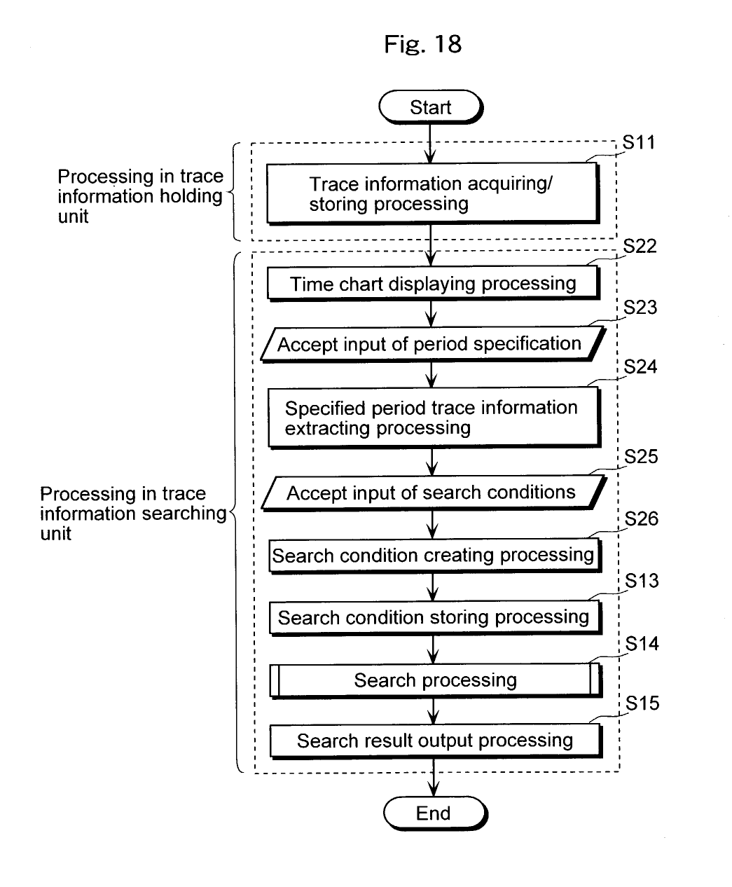

The following is an explanation of the operation of the trace information searching device 2000 in the present embodiment. FIG. 18 is a flowchart showing the processing flow of the trace information searching device 2000.

First, the trace information holding unit 1100 acquires trace information while the target application is running and stores it (Step S11) as in the case of the First Embodiment. When all trace information is stored, the time chart displaying unit 2311 of the trace information searching unit 2200 reads out trace information from the trace information memory unit 1120 to display it in time chart form (Step S22).

Next, the specified period extracting unit 2312 accepts the operator's specification of a period to be searched on the time chart (Step S23) and extracts trace information corresponding to the specified period (Step S24).

Furthermore, the search condition creating unit 2313 accepts the operator's input of search conditions (Step S25), creates the event occurrence order table and the rejection event table which reflect this input (Step S26) and stores the event occurrence order table and the rejection table created in the search condition memory unit 2220 (Step S13).

Then, the searching unit 2230 reads out the search conditions stored in the search condition memory unit 2220, based on which it searches among the trace information (Step S14) and displays the result in time chart form (Step S15).

Note that the same flowchart of the First Embodiment is applicable to this search processing (Step S14) (refer to FIG. 5 above).

As above, in addition to the above-mentioned functionality in the First Embodiment, the trace information searching device 2000 in the present embodiment provides the operator with an efficient is search condition input unit by allowing the operator to take out a part of the trace information through period specification on a time chart and to create an event occurrence order table and a rejection event table using the part of the trace information. Furthermore, since a desired OS operation can be visually displayed on the time chart, input of search conditions also becomes easy. Moreover, it is also possible to reduce the time required by the operator to create search conditions needed to specify a defective part in an application.

Another Embodiment

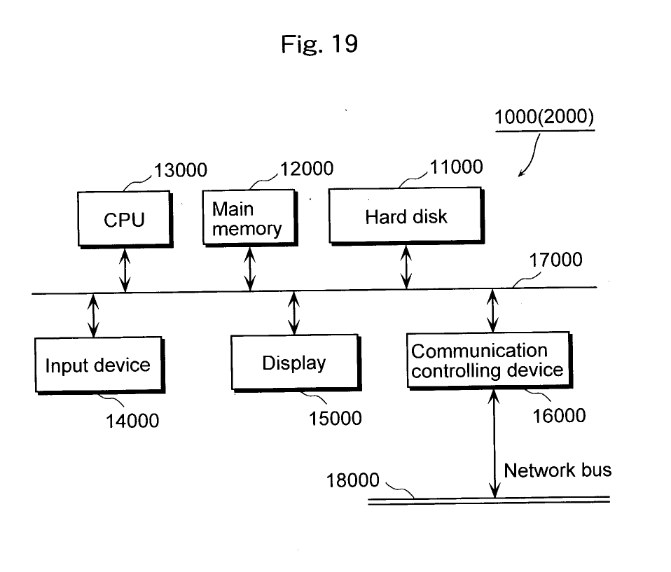

FIG. 19 is an example hardware configuration illustrating the case where each function of the trace information searching device 1000 or 2000 in the First Embodiment or the Second Embodiment is realized by using a CPU (Central Processing Unit) and others. As shown in FIG. 19, the trace information searching device 1000 or 2000 has a hard disk 11000, a main memory 12000, a CPU 13000, an input device 14000, a display 15000, and a communication controlling device 16000, all of which are interconnected by a bus 17000.

Search conditions to be stored in the search condition memory unit 1220 or 2220 in the trace information searching unit 1000 or 2000, the trace information, the target application 1010 used for searching the trace information and others are stored on the hard disk 11000. The trace information memory unit 1120 in the First Embodiment and the Second Embodiment corresponds to this hard disk 11000. A target application and others stored on the hard disk 11000 are loaded into the main memory 12000. The CPU 13000 executes a program loaded into the main memory 12000.

The input device 14000, which can be a keyboard, a mouse and so forth, partly corresponds to the functionality of the search condition input unit 1210 in the trace information searching device 1000, the specified period extracting unit 2312 and the search condition creating unit 2313 in the trace information searching device 2000. Through this input device 14000, commands are sent to the CPU 13000. The display 15000 is a display device equipped with a CRT, a liquid crystal panel or others for displaying a search result, the time chart and others.

The communication controlling device 16000 controls data receiving between the target application 1010 and another application via a network bus 18000.

An explanation of the trace information searching device according to the present invention is provided in the above paragraphs based on the present embodiments, but it should be understood that the present invention is not restricted to the given embodiments, which therefore means:

(1) In the First Embodiment and the Second Embodiment, although it is described that all trace information is to be acquired while the application is running, switching between “ON” and “OFF” can be performed for trace information acquisition in the trace information acquiring unit 1110 where necessary.

(2) In the First Embodiment and the Second Embodiment, although the event occurrence order table and the rejection event table are used as search conditions, it is also acceptable as long as OS-related conditions explained in each embodiment can be set, which therefore means that the form of the event occurrence order table and the rejection event table does not necessarily have to be adopted.

(3) In the First Embodiment and the Second Embodiment, although the detailed algorithm is explained for search processing, lo it is also acceptable as long as a part which matches/mismatches search conditions can be detected in the trace information, which means that the detailed algorithm for search processing is not mandatory.

(4) In the First Embodiment and the Second Embodiment, although the time unit is given in msec, it is also acceptable as long as a time unit appropriate to actual trace information is adopted, which means that msec does not necessarily have to be used.

(5) In the First Embodiment, although it is described that processing for search condition input acceptance is performed after trace information acquiring/storing processing in FIG. 4, it is also acceptable that trace information acquiring/storing processing (Step S11) and a series of processing from search condition input acceptance (Step S12) to search condition storage (Step S13) are performed in parallel, since the completion of trace information acquiring/storing processing (Step Sll) can be accepted until just before searching processing (Step S14),

(6) In the Second Embodiment, although it is described that the operator inputs search conditions on the time chart which displays only trace information extracted by the specified period extracting unit 2312, it is also acceptable that the operator performs a search by using a part of trace information extracted by the specified period extracting unit 2312 as it is as the event occurrence order table without inputting search conditions. In this case, reference is not to be made to the descriptions in the rejection event table.

What is claimed is:

1. A trace information searching device which performs a search, under specific search conditions, among trace information indicating an operation history of an application program which operates on a specified operating system and in which two or more kinds of events occur, the trace information searching device comprising:
a trace information acquiring unit operable to acquire the trace information on a time series basis;
a search condition acquiring unit operable to acquire search conditions concerning the events;
a searching unit operable to search trace information which matches the acquired search conditions among the- acquired trace information; and
a search result displaying unit operable to display the contents of trace information searched by the searching unit.

2. The trace information searching device according to claim 1,
wherein the search conditions include information indicating an occurrence order of the events.

3. The trace information searching device according to claim 2,
wherein the search conditions further include information indicating an occurrence interval of the events.

4. The trace information searching device according to claim 2,
wherein the search conditions further include information concerning an event indicating that the event shall be treated as not having occurred when the search is performed.

5. The trace information searching device according to claim 2,
wherein the search conditions further include:
information indicating an occurrence interval of the events; and
information concerning an event indicating that the event shall be treated as not having occurred when the search is performed.

6. The trace information searching device according to claim 5,
wherein the search condition acquiring unit comprising:
a time chart displaying unit operable to display the trace information as a time chart;
a specified period extracting unit operable to accept specification of an arbitrary period on the time chart and to extract trace information corresponding to the time chart of the specified period as trace information to be searched; and
a search condition creating unit operable to acquire and create the search conditions on the time chart from among the extracted trace information.

7. The trace information searching device according to claim 6 further comprising:
a first memory unit operable to memorize the acquired trace information; and
a second memory unit operable to memorize the acquired search conditions,
wherein the searching unit performs the search by reading out trace information from the first memory unit and reading out search conditions from the second memory unit.

8. The trace information searching device according to claim 7,
wherein the events are at least any two or more events out of a task transition occurrence event, an interrupt occurrence event and a system call issue event.

9. The trace information searching device according to claim 1,
wherein the search result displaying unit displays the contents of the searched trace information in time chart form.

10. The trace information searching device according to claim 1,
wherein the search result displaying unit further displays time on one display axis and displays a task name or an interrupt processing name on the other display axis based on the contents of the searched trace information.

11. The trace information searching device according to claim 10,
wherein the search result displaying unit further shows, when all the search conditions are matched in succession, which part of the trace information are matched all the search conditions, based on the contents of the searched trace information.

12. The trace information searching device according to claim 1,
wherein the search result displaying unit further shows, when the search conditions are partially matched, which part of the trace information are partially matched or which part of the trace information are partially mismatched, based on the contents of the searched trace information.

13. A trace information searching method for performing a search, under specific search conditions, among trace information indicating an operation history of an application program which operates on a specified operating system and in which two or more kinds of events occur, the trace information searching method comprising:
a trace information acquiring step for acquiring the trace information on a time series basis;
a search condition acquiring step for acquiring search conditions concerning the events;
a searching step for searching trace information which matches the acquired search conditions among the acquired trace information; and
a search result displaying step for displaying the contents of trace information searched at the searching step.

14. The trace information searching method according to claim 13,
wherein the search conditions include information indicating an occurrence order of the events.

15. The trace information searching method according to claim 14,
wherein the search conditions further include information indicating an occurrence interval of the events.

16. The trace information searching method according to claim 14,
wherein the search conditions further include information concerning an event indicating that the event shall be treated as not having occurred when the search is performed.

17. The trace information searching method according to claim 14,
wherein the search conditions further include:
information indicating an occurrence interval of the events; and
information concerning an event indicating that the event shall be treated as not having occurred when the search is performed.

18. The trace information searching method according to claim 17,
wherein the search condition acquiring step comprising:
a time chart displaying sub-step for displaying the trace information as a time chart;
a specified period extracting sub-step for accepting specification of an arbitrary period on the time chart and for extracting trace information corresponding to the specified period on the time chart as trace information to be searched; and
a search condition creating sub-step for acquiring and creating the search conditions on the time chart from among the extracted trace information.

19. A program for a trace information searching device which performs a search, under specific search conditions, among trace information indicating an operation history of an application program which operates on a specified operating system and in which two or more kinds of events occur, the program having a computer execute:
a trace information acquiring step for acquiring the trace information on a time series basis;
a search condition acquiring step for acquiring search conditions concerning the events;
a searching step for searching trace information which matches the acquired search conditions among the acquired trace information; and
a search result displaying step for displaying the contents of trace information searched at the searching step.

20. The program according to claim 19,
wherein the search conditions include alt least one of the following information: information indicating an occurrence order of the events, information indicating an occurrence interval of the events, and information concerning an event indicating that the event shall be treated as not having occurred when the search is performed.

21. The program according to claim 20,
wherein the search condition acquiring step has:
a time chart displaying sub-step for displaying the trace information as a time chart;
a specified period extracting sub-step for accepting specification of an arbitrary period on the time chart and for extracting trace information corresponding to the specified period on the time chart as trace information to be searched; and
a search condition creating sub-step for acquiring and creating the search conditions on the time chart from among the extracted trace information.
